(19) United States
(12) Patent Application Publication
(10) Pub. No.: US 2026/0368857 A1
(43) Pub. Date: Nov. 19, 2026

(54) SIGHT IMAGE PROCESSING METHOD AND APPARATUS, AND BIFOCAL DIGITAL SIGHT

(71) Applicant: Shenzhen Yixin Information Technology Co., Ltd., Shenzhen (CN)

(72) Inventor: Lei WANG, Shenzhen (CN)

(73) Assignee: Shenzhen Yixin Information Technology Co., Ltd., Shenzhen (CN)

(21) Appl. No.: 19/209,656

(22) Filed: May 15, 2025

(51) Int. Cl. G06T 5/50; G06T 3/02; G06T 7/13; G06T 7/33; G06V 10/44; G06V 10/46; G06V 10/54

(52) U.S. Cl. CPC G06T 5/50; G06T 3/02; G06T 7/13; G06T 7/33; G06V 10/44; G06V 10/46; G06V 10/54; G06T 2207/10048; G06T 2207/20221

(57) ABSTRACT

The present application discloses a sight image processing method and apparatus, and a bifocal digital sight. The sight image processing method includes the following steps: acquiring initial visible light image data and initial infrared image data of a target region; performing image registration operation on the initial visible light image data and the initial infrared image data to obtain a registered visible light image and a registered infrared image; and performing image fusion operation on the registered visible light image and the registered infrared image to obtain a fused image. According to the solution, the present application improves operation convenience and use efficiency, increases the accuracy of target recognition, and improves the adaptability and reliability of the sight under a complex environment.

### FIELD OF THE INVENTION

The present application relates to the technical field of sights, and particularly relates to a sight image processing method and apparatus, and a bifocal digital sight.

### BACKGROUND OF THE INVENTION

A bifocal digital sight is a sighting device combining an infrared sensor and a visible light sensor. The infrared sensor can receive infrared rays emitted or reflected by an object, and enhance the visibility of a target by thermal imaging, and it is especially suitable for observing moving animals, people and vehicles. The visible light sensor has a good performance on detailed features of the object, and can clearly present the environmental information, which is more in line with the observation habits of the naked eye.

In the related technology, the bifocal digital sight can only support simple switching between an infrared image picture and a visible light image screen, and needs to be manually switched back and forth in actual use, which is cumbersome in operation and inconvenient to use.

### TECHNICAL PROBLEM

When using the bifocal digital sight, it is necessary to switch back and forth between the infrared image picture and the visible light image picture, which is cumbersome in operation and inconvenient to use.

### TECHNICAL SOLUTION

The main objective of the present application is to provide a sight image processing method to solve the technical problem that an existing bifocal digital sight needs to be switched between an infrared image picture and a visible light image picture back and forth, which is cumbersome in operation and inconvenient to use.

In order to achieve the above objective, the present application provides a sight image processing method which includes the following steps:
acquiring initial visible light image data and initial infrared image data of a target region;
performing image registration operation on the initial visible light image data and the initial infrared image data to obtain a registered visible light image and a registered infrared image; and
performing image fusion operation on the registered visible light image and the registered infrared image to obtain a fused image.

### BENEFICIAL EFFECT

According to the technical solution, the sight image processing method is provided, the acquired initial visible light image data and the acquired initial infrared image data are combined to form the fused image by the image registration technology and the image fusion technology, and the fused image improves the visual effect of the image and combines the advantages of the visible light image and the infrared image; in actual application process, a user does not need to manually switch the images back and forth, but can acquire environment detail features and thermal feature information of the target region at the same time by the fused image, and accordingly the operation convenience and the use efficiency are greatly improved; and because the fused image can provide richer target information, the target recognition accuracy is improved, the adaptability and reliability of the sight in a complex environment are improved, furthermore, the operation experience of the user is improved, and powerful technical supports are provided for improving the sighting precision and efficiency.

### BRIEF DESCRIPTION OF THE DRAWINGS

FIG. 1 is a flow schematic diagram of an embodiment of a sight image processing method according to the present application;

FIG. 2 is a modular schematic structural diagram of a sight image processing apparatus according to an embodiment of the present application;

FIG. 3 is a schematic structural diagram of an embodiment of a bifocal digital sight according to the present application; and

FIG. 4 is a schematic structural diagram of a device in a hardware operating environment involved in a sight image processing method according to the present application.

### REFERENCE NUMERALS

1, image processing main control board; 2, objective lens optical module; 3, display apparatus; 4, eyepiece optical module; 5, visible light image sensor; and 6, infrared image sensor.

### DETAILED DESCRIPTION OF SOME EMBODIMENTS

An embodiment of the present application provides a sight image processing method, with reference to FIG. 1, the sight image processing method includes the following steps:
acquiring initial visible light image data and initial infrared image data of a target region;
performing image registration operation on the initial visible light image data and the initial infrared image data to obtain a registered visible light image and a registered infrared image; and
performing image fusion operation on the registered visible light image and the registered infrared image to obtain a fused image.

In this embodiment, the initial visible light image data are acquired by a visible light sensor; and the visible light sensor receives light rays with a visible light band in the target region to produce image data which reflect the environment detail features of the target region.

The initial infrared image data are acquired by an infrared sensor; and the infrared sensor receives infrared radiation of the target region to produce thermal imaging data which reflect the temperature distribution situation of the target region.

The image registration operation aims at solving the problems of translation, rotation and affine and other position deviation of the two images caused by the difference of imaging devices, imaging visual angle and environmental factors so that the consistency of the corresponding regions of the two images in space can be ensured.

The image fusion operation is to integrate the two registered images according to a certain mode so as to produce the fused image; and the fused image includes partial or all image information of both the registered images so that advantage complementation of the image information can be realized, and the user can acquire required image information in the two images before fusion from one image after fusion.

In practical application, the initial visible light image data and the initial infrared image data of the target region are acquired by the visible light sensor and the infrared sensor respectively. The visible light sensor can capture visible light information of the target region and provide rich environment details, texture information and the like; and the infrared sensor can capture thermal radiation information of a target object in the target region, and the thermal features of the target object can be clearly displayed even under a low-light or non-light condition. The image data acquired by the two sensors contain different information of the target region, which provides a basis for subsequent image processing.

Then, it is needed to perform the image registration operation, which is one of the key steps of the whole method. Because the visible light sensor and the infrared sensor are different in physical position, view angle, optical characteristic and the like, the images acquired by the two are not completely consistent in geometric position. The image registration operation aims at aligning the two images in space by a certain algorithm so that the same target is at the same position in the two images. This step generally relates to feature extraction, feature matching, geometric transformation and other operation; for example, features points in the two images can be extracted by a feature point detection algorithm (such as SIFT and ORB), then the corresponding relationship between the two images is obtained by a feature matching algorithm (such as a Brute-Force matching algorithm and an FLANN matching algorithm), and finally one image is transformed by geometric transformation (such as affine transformation and perspective transformation) to be aligned with the other image.

After the image registration operation, it is needed to perform the image fusion operation. The image fusion operation aims at integrating the image information of the registered visible light image and the image information of the registered infrared image to produce a fused image that contains more target information. There can be various specific image fusion methods, such as pixel-level-based fusion, feature-level-based fusion, and decision-level-based fusion; and more specifically, the pixel values of the two images can be subjected to weighted average according to a certain weight, or the features such as edges and textures in the two images are extracted for fusion, or targets in the two images can be recognized and determined according to a certain rule, and then the recognition results are fused. The fused image can show the environmental details and the thermal features of the target region at the same time, so that the environmental adaptability of the sight and the recognition capability of the sight on the target are improved.

In view of above, according to the present application, the acquired initial visible light image data and the acquired initial infrared image data are combined to form the fused image by the image registration technology and the image fusion technology, and the fused image improves the visual effect of the image and combines the advantages of the visible light image and the infrared image; in actual application process, the user does not need to manually switch the images back and forth, but can acquire the environment detail features and the thermal feature information of the target region at the same time by the fused image, and accordingly the operation convenience and the use efficiency are greatly improved; and because the fused image can provide richer target information, the target recognition accuracy is improved, the adaptability and reliability of the sight in the complex environment are improved, furthermore, the operation experience of the user is improved, and powerful technical supports are provided for improving the sighting precision and efficiency.

Further, with reference to FIG. 1, before the step of performing image registration operation on the initial visible light image data and the initial infrared image data, the method includes:
performing image preprocessing operation on the initial visible light image data and/or the initial infrared image data.

The image preprocessing operation is an important link in image processing and aims at improving the image quality, reducing noise interference and improving the accuracy of subsequent image processing. On the basis of the solution in this embodiment, the amount of computation of the subsequent image registration operation and image fusion operation can be reduced, and the accuracy of image registration and image fusion is improved, and therefore, the quality of the finally obtained fused image can be improved, and the robustness of the system is enhanced.

Further, with reference to FIG. 1, the image preprocessing operation includes any one or more of bad pixel correction, noise reduction, filtering, gamma correction, image enhancement and scaling.

Specifically, the bad pixel correction operation refers to recognizing and correcting abnormal pixel points in the image, and the pixel points may be caused by sensor faults or external interference.

The noise reduction operation aims at reducing random noise in the image and improving the definition of the image.

The filtering operation can smooth the image by a specific algorithm so as to remove high-frequency noise.

The gamma correction operation is to perform nonlinear adjustment on the gray value of the image to improve the visual effect of the image.

The image enhancement operation is to make the target more prominent by adjusting parameters such as contrast and brightness of the image.

The scaling operation is to adjust the size of the image according to actual requirements so as to meet the requirements of subsequent image processing.

The image preprocessing operation can be carried out only for the initial visible light image data, or only for the initial infrared image data, or for both the initial visible light image data and the initial infrared image data at the same time, which is not limited here. In addition, in the image preprocessing operation, it can be flexibly selected and combined according to actual needs so as to obtain the optimal image quality effect. For example, under a low-light condition, image enhancement operation and noise reduction operation can be emphatically carried out so as to improve the visibility and definition of the image; and under a strong-noise environment, filtering operation and noise reduction operation can be emphatically carried out.

By the image preprocessing operation, the quality of the initial visible light image data and/or the initial infrared image data can be effectively improved, and thus a more reliable data basis is provided for subsequent image registration operation and image fusion operation.

Further, with reference to FIG. 1, the step of performing image registration operation on the initial visible light image data and the initial infrared image data includes:
extracting a first feature point of the initial visible light image data;
extracting a second feature point of the initial infrared image data;
computing a registration matrix based on the first feature point and the second feature point; and
aligning the initial visible light image data and the initial infrared image data by the registration matrix.

The extraction of the feature points is a key step of the image registration operation, and a corresponding relationship between the two images can be established by recognizing salient points in the images. By extracting the first feature point of the initial visible light image data and the second feature point of the initial infrared image data, the corresponding relationship between the initial visible light image and the initial infrared image can be established, thus providing a basis for computation of the registration matrix.

The registration matrix is a matrix used for describing the transformation relationship between two or more images, it reflects the change rule of the images in geometrical shape and texture and can provide a basis for achieving image matching, fusion and transformation. By the registration matrix computed based on first feature point and second feature point, coordinate systems of the initial visible light image and the initial infrared image can be aligned, so that a reliable basis is provided for subsequent image fusion operation, and it is guaranteed that the information of the visible light image and the information of the infrared image can be accurately integrated in subsequent image fusion operation.

Further, with reference to FIG. 1, the first feature point includes any one or more of corner points, edge points, texture regions and interest points.

Further, with reference to FIG. 1, the second feature point includes any one or more of corner points, edge points, texture regions and interest points.

Specifically, the corner points refer to intersection points of two edges in the images and usually have high uniqueness.

The edge points refer to points with remarkable gray level changes in the images and can reflect the outline of the object.

The texture regions refer to regions with specific texture modes in the images and can provide rich detail information.

The interest points may include the corner points, the edge points and other points with remarkable features in the images and can be used for effectively distinguishing different images.

The selection of the first feature point depends on the content and application scenario of the visible light image. For example, in a complex scenario, it may be needed to use the corner points, the edge points and the texture regions at the same time as the first feature point so as to ensure the accuracy of subsequent image registration operation. The corner points can provide a stable corresponding relationship due to their unique geometrical features; the edge points can reflect contour information of the object and are beneficial to determining the position and shape of the object; the texture regions can provide rich detail information, which are beneficial to performing accurate registration in regions with rich textures; and the interest points are points which are extracted according to a specific algorithm and have remarkable features, and can establish a reliable corresponding relationship between different images. By reasonably selecting and combining the above feature points, the accuracy and reliability of image registration operation can be improved.

The same as the selection of the first feature points, the selection of the second feature points also depends on the features and application scenario of the infrared image. The imaging principle of the infrared image is different from that of the visible light image, and there may be difference in extraction of some feature points; for example, temperature change in the infrared image may increase the difficultly in extraction of the edge points, and it may be obvious in the texture regions. Therefore, when extracting the second feature point from the initial infrared image data, different algorithms and strategies may be needed. By reasonably selecting and extracting the second feature point, accurate registration between the infrared image and the visible light image can be achieved, and thus a reliable basis is provided for subsequent image fusion operation.

Further, with reference to FIG. 1, the step of computing a registration matrix based on the first feature point and the second feature point includes:
performing feature point matching operation on the first feature point and the second feature point to obtain feature point matching results; and
computing the registration matrix according to the feature point matching results.

The feature point matching operation aims at establishing a corresponding relationship between two sets of feature points and determining a geometric transformation relationship between the two sets of feature points; by establishing the corresponding relationship, wrong feature point pairs in the first feature point and the second feature point can be removed, the feature point matching results (the feature point matching results are the correct feature point pairs in the first feature point and the second feature point) are obtained, then the registration matrix is computed by the feature point matching results, and therefore, it can be ensured that the registration process is carried out based on the correct feature point corresponding relationship, thereby improving the registration precision, and enhancing the robustness of the registration process; in addition, the wrong feature point pairs are removed, so that unnecessary computation is reduced; and the processing is only performed on the matched feature point pairs subsequently, which improves the computation efficiency.

Further, with reference to FIG. 1, the step of performing feature point matching operation on the first feature point and the second feature point includes:
performing the feature point matching operation on the first feature point and the second feature point by at least one of a Brute-Force algorithm, a FLANN algorithm and an RANSAC algorithm.

Specifically, the principle of the Brute-Force algorithm is that all possible matching combinations are exhaustively used for finding the best matched feature point pair from the first feature point and the second feature point.

The principle of the FLANN (Fast Library for Approximate Nearest Neighbors) algorithm is that an index structure is used for accelerating nearest neighbor search to improve the matching efficiency.

The principle of the RANSAC (Random Sample Consensus) algorithm is that abnormal matching points are removed by random sampling and model estimation so as to improve the matching robustness.

The above feature point matching algorithms have respective advantages and suitable application scenarios, and the Brute-Force algorithm can guarantee the matching accuracy on a small-scale data set; the FLANN algorithm is suitable for a large-scale data set and can quickly find out the nearest neighbor to match; and the RANSAC algorithm is excellent under the condition that a large number of abnormal points exist, and can effectively improve the matching robustness. By reasonably selecting and combining the above feature point matching algorithms, the matching efficiency and accuracy of the first feature point and the second feature point can be improved, and thus reliable data support is provided for subsequent computation of the registration matrix.

Further, with reference to FIG. 1, the step of computing the registration matrix according to the feature point matching results includes:
computing the registration matrix by at least one of rigid transformation, affine transformation, perspective transformation and thin plate spline interpolation.

Specifically, the rigid transformation includes translation and rotation and is suitable for a condition that only rigid motion exists between two images.

The affine transformation can describe translation, rotation, scaling, shearing and other transformation and is suitable for a condition that linear transformation exists between two images.

The perspective transformation can process projection transformation and is suitable for a condition that perspective difference exists between two images.

The thin plate spline interpolation is a nonlinear transformation method and can process complex geometric deformation.

The transformation method can describe different geometric relationships between two images, the registration matrix can be accurately calculated by selecting a proper transformation method, and accurate alignment of the visible light image and the infrared image is achieved.

Further, with reference to FIG. 1, the step of performing image fusion operation on the registered visible light image and the registered infrared image includes:
selecting a first image region and a second image region from the registered infrared image, in which, at least a part of the first image region is in the second image region, and color difference exists between the first image region and the second image region; and
overlaying the color of the first image region and the color of the second image region to a corresponding region of the registered visible light image.

The image fusion operation aims at integrating temperature information in the registered infrared image and environment detail information in the registered visible light image to produce a fused image that contains more target information. In this embodiment, the first image region and the second image region are selected from the registered infrared image, the first image region can specifically refer to the region occupied by moving objects such as animals, people and vehicles in the registered infrared image, and the second image region can specifically refer to at least a part of a background environment region with the moving objects; there is remarkable temperature difference between the first image region and the second image region, that is, the color difference between the two image regions is obvious in the registered infrared image; the color information of the two image regions is overlaid to the corresponding region of the registered visible light image (namely, the image region corresponding to the moving object in the registered visible light image and the background environment region with the moving object), thus the environment information and the temperature distribution information of the target region can be displayed in the fused image at the same time, which helps the user to acquire clear background detail features, as well as achieves rapid and accurate recognition to the target object (namely, the moving object corresponding to the first image region) in the image.

Further, with reference to FIG. 1, the step of performing image fusion operation on the registered visible light image and the registered infrared image includes:
selecting the first image region and the second image region from the registered infrared image, in which, at least a part of the first image region is in the second image region, and color difference exists between the first image region and the second image region;
performing edging processing on boundaries of the first image region and the second image region with a first target color to obtain a target contour line; and
overlaying the target contour line to the boundary of the corresponding region of the registered visible light image.

In this embodiment, the first image region and the second image region are selected from the registered infrared image, the first image region can specifically refer to the region occupied by moving objects such as animals, people and vehicles in the registered infrared image, and the second image region can specifically refer to at least a part of the background environment region with the moving objects; there is remarkable temperature difference between the first image region and the second image region, that is, the color difference between the two image regions is obvious in the registered infrared image; then the boundaries of the first image region and the second image region are subjected to edging processing with the first target color to obtain the target contour line (namely the contour line of the moving object corresponding to the first image region) of the target object; and then the target contour line is overlaid to the boundary of the corresponding region (namely the contour line of the image region corresponding to the moving object in the registered visible light image) of the registered visible light image, and therefore the contour line of the target object can be highlighted in the fused image. The first target color can be obviously different from the background color in the registered visible light image.

In this embodiment, the boundaries of different temperature regions in the registered infrared image are marked with the first target color to produce the contour line of the target object, the contour line is overlaid to the corresponding region of the registered visible light image, and therefore the contour of the target object can be clearly shown in the fused image, which helps the user to acquire clear background detail features and improves the recognition rapidity and accuracy of the user to the target object; in addition, in the edging mode, the color only covers the contour line of the target object, and the color can be prevented from completely covering the target object, so that it can be guaranteed that the user can still accurately observe the internal detail features (namely the detail features of the region within the contour line of the target object) of the target object when the target object in the fused image is recognized.

Further, with reference to FIG. 1, before the step of performing image fusion operation on the registered visible light image and the registered infrared image, the method includes:
carrying out graying processing on the registered visible light image.

The graying processing is a process of transforming the color image into a gray image and aims at reducing the data volume and improving the processing efficiency. Specifically, the graying processing can be implemented by various methods such as a mean value method and a weighted mean value method; the mean value method is to average the values of three components RGB as the gray values; and the weighted mean value method is to provide different weights to the three components RGB for computation according to the sensitivity of human eyes to different colors.

In this embodiment, before the image fusion operation, the registered visible light image is transformed into the gray image by the graying processing. The data volume of the registered visible light image subjected to the graying processing is greatly decreased, so that subsequent computation complexity is reduced, moreover, interference caused by excessive color information on the subsequent fusion result can be avoided, the registered visible light image can be better fused with the registered infrared image; and a coloring region or the contour line corresponding to the target object can be highlighted in the grayed background, thus facilitating the user to perform accurate recognition on the target object.

Further, with reference to FIG. 1, the step of performing image fusion operation on the registered visible light image and the registered infrared image includes:
selecting the first image region and the second image region from the registered infrared image, in which, at least a part of the first image region is in the second image region, and color difference exists between the first image region and the second image region;
overlaying the color of the first image region and the color of the second image region to the corresponding region of the registered visible light image to obtain a pseudo-color fused image;
selecting the first image region and the second image region from the registered infrared image, in which, at least a part of the first image region is in the second image region, and color difference exists between the first image region and the second image region;
performing edging processing on boundaries of the first image region and the second image region with the first target color to obtain the target contour line;
overlaying the target contour line to the boundary of the corresponding region of the registered visible light image to obtain a contour fused image; acquiring external environment parameters; and
dynamically selecting the pseudo-color fused image or the contour fused image as a final display image according to the external environment parameters.

In this embodiment, a dynamic selection mechanism provided, which can automatically select a fused image most suitable for the current use environment according to the actual situation, thereby improving the adaptability and practicability of the sight. The external environment parameters can include light intensity, visibility, wind speed, precipitation, snowfall and the like. Exemplarily, the color coverage area of the pseudo-color fused image is larger, so it is more suitable for being used at low visibility to help the user to rapidly recognize and lock the target object; although the color coverage area of the contour fused image is small, the color does not completely cover the target object, and the internal detail features of the target object can be displayed, so it is more suitable for being used at high visibility to help the user to observe the internal detail features of the target object under the condition that the target object is recognized.

In the specific implementation process, a threshold condition can be set in advance based on the external environment parameters; and when the current external environment parameters are acquired by a corresponding sensing apparatus, whether the current external environment parameters meet the threshold condition or not can be determined, and the pseudo-color fused image or the contour fused image is correspondingly selected as the final display image to be presented to the user according to the determination result.

Further, with reference to FIG. 1, after the step of performing image fusion operation on the registered visible light image and the registered infrared image, the method includes:
acquiring the external environment parameters; and
according to the external environment parameters, dynamically adjusting the fusion weight between the registered visible light image and the registered infrared image.

In this embodiment, a dynamic adjustment mechanism is provided, which can automatically optimize the quality of the fused image in real time according to the environmental change condition. The external environment parameters can include light intensity, visibility, wind speed, precipitation, snowfall and the like. Exemplarily, in a high-light environment, the weight of the registered visible light image can be properly increased to improve the visibility of environmental details; and in a low-light environment, the weight of the registered infrared image can be properly increased to highlight the temperature information.

In the specific implementation process, a table of a mapping relationship between the external environment parameters and the fusion weight (including the weight of the registered visible light image and the weight of the registered infrared image) can be set in advance; and when the current external environment parameters are acquired by the corresponding sensing apparatus, the fusion weight corresponding to the current external environment parameters can be searched from the mapping relationship table based on a table lookup method and adjusted in real time.

By the above dynamic adjustment mechanism, the optimization of the performance quality of the fused image in different application environments can be automatically realized, so that the user experience is improved.

Further, with reference to FIG. 1, the external environment parameters include environmental light intensity.

The environmental light intensity is one of the important factors that affect the image fusion effect, and the fusion strategy can be accurately adjusted by monitoring the environmental light intensity in real time. For example, when the environmental light intensity is high, the quality of the visible light image is good, and the fusion weight of the registered visible light image can be properly increased at the moment; and when the environmental light intensity is low, the thermal imaging advantage of the infrared image is more obvious, and the fusion weight of the registered infrared image can be properly increased at the moment.

The dynamic adjustment mechanism based on the environmental light intensity can effectively improve the adaptability of the fused image, thereby improving the use stability of the sight under different light conditions.

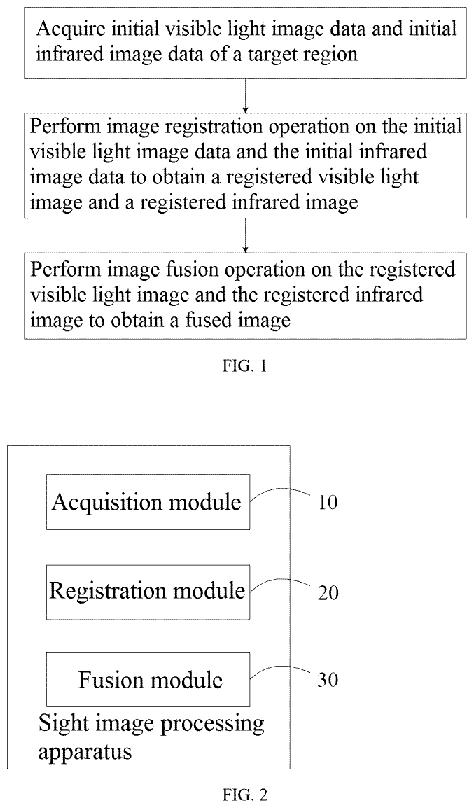

Correspondingly, an embodiment of the present application also provides a sight image processing apparatus, with reference to FIG. 2, the sight image processing apparatus includes:
an acquisition module 10, configured to acquire initial visible light image data and initial infrared image data of a target region;
a registration module 20, configured to perform image registration operation on the initial visible light image data and the initial infrared image data to obtain a registered visible light image and a registered infrared image; and
a fusion module 30, configured to perform image fusion operation on the registered visible light image and the registered infrared image to obtain a fused image.

The sight image processing apparatus by this embodiment corresponds to the sight image processing method in the above embodiment, and can solve the technical problem that an existing bifocal digital sight needs to be switched between an infrared image picture and a visible light image picture back and forth, which is cumbersome in operation and inconvenient to use. Compared with the related technology, the sight image processing apparatus provided by this embodiment has the same beneficial effects as the sight image processing method provided by the above embodiment, other technical features in the sight image processing apparatus are the same as those disclosed by the sight image processing method provided by the above embodiment, which will not be listed here.

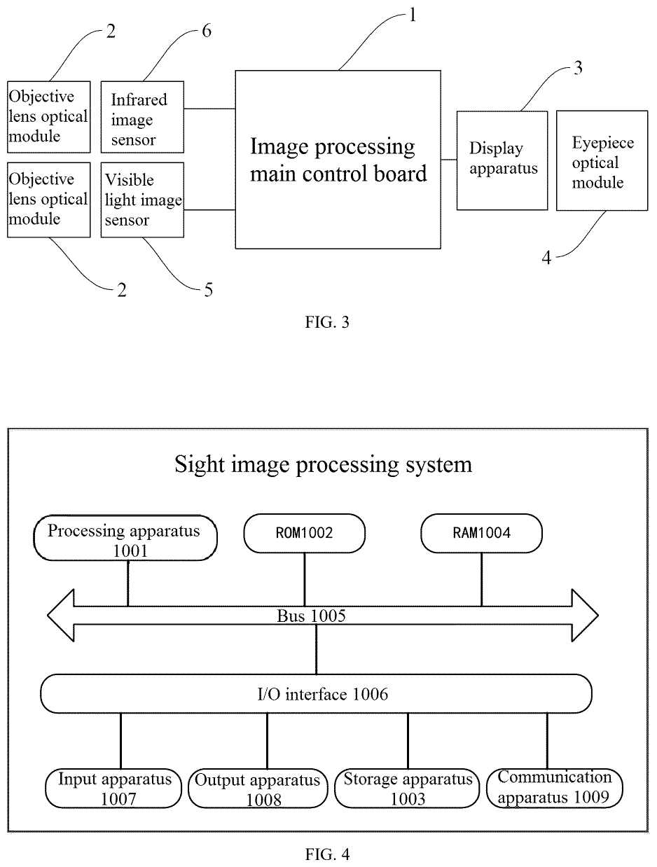

Correspondingly, an embodiment of the present application further provides a bifocal digital sight, with reference to FIG. 3, the bifocal digital sight includes the sight image processing apparatus in any embodiment above.

The bifocal digital sight provided by this embodiment can be specifically applied to apparatuses or devices such as firearms, observation apparatuses and unmanned aerial vehicles. Because adopting all the technical solutions of all the embodiments above, the bifocal digital sight has at least all the beneficial effects in the technical solutions of the embodiments above, which will not be listed here.

Further, with reference to FIG. 2 and FIG. 3, the bifocal digital sight further includes an objective lens optical module 2, a display apparatus 3 and an eyepiece optical module 4, in which, the objective lens optical module 2 is arranged at an input end of the acquisition module 10, the display apparatus 3 is electrically connected to the fusion module 30 and configured to present the fused image, and the eyepiece optical module 4 is arranged at a display end of the display apparatus 3.

In this embodiment, as shown in FIG. 2 and FIG. 3, the registration module 20 and the fusion module 30 of the sight image processing apparatus can be integrated on an image processing main control board 1; a visible light image sensor 5 and an infrared image sensor 6 can be adopted as the acquisition module 10 of the sight image processing device; an input end of the image processing main control board 1 is electrically connected to the visible light image sensor 5 and the infrared image sensor 6; an induction end of the visible light image sensor 5 and an induction end (corresponding to an input end of the acquisition module 10) of the infrared image sensor 6 are each provided with the objective lens optical module 2; an output end (corresponding to the fusion module 30) of the image processing main control board 1 is electrically connected to the display apparatus 3; and the eyepiece optical module 4 is arranged at the display end of the display apparatus 3.

The objective lens optical module 2 is configured to focus the light rays of the target region to the induction end of the visible light image sensor 5 and the induction end of the infrared image sensor 6 so as to ensure the definition and resolution ratio of the image. The display apparatus 3 is configured to present the fused image obtained after processing by the image processing main control board 1 on the display end (specifically referring to a display screen) in a visual mode so as to facilitate observation. The eyepiece optical module 4 is configured to amplify the fused image presented by the display end of the display apparatus 3 so as to help the user to observe and recognize detail features in the fused image more clearly.

Correspondingly, an embodiment of the present application further provides a sight image processing system, with reference to FIG. 4, the sight image processing system includes: a memory, a processor, and computer programs which are stored in the memory and can run in the processor; and the computer programs are configured to implement the steps of the sight image processing method in any embodiment above.

With reference to FIG. 4, it is a schematic structural diagram of the sight image processing system suitable for implementing the embodiment of the present application. The sight image processing system in this embodiment of the present application can include but is not limited to mobile terminals such as a mobile phone, a notebook computer, a digital broadcast receiver, a PDA (personal digital assistant), a PAD (tablet personal computer), a PMP (portable multimedia player), and a vehicle-mounted terminal (such as a vehicle-mounted navigation terminal), and immobile terminals such as a digital TV, a desktop computer. The sight image processing system shown in FIG. 5 is only an example, and does not bring any limitation to the functions and the use range of the embodiment of the present application.

As shown in FIG. 4, the sight image processing system can include a processing apparatus (such as a central processor, and a graphic processor) 1001, which can perform various appropriate actions and processing according to a program stored in a read-only memory (ROM) 1002 or a program loaded from a storage apparatus 1003 to a Random Access Memory (RAM) 1004. In the RAM 1004, various programs and data required for operation of the xxx device are also stored. The processing apparatus 1001, ROM 1002 and RAM 1004 are connected to one another through a bus 1005. An input/output (I/O) interface 1006 is also connected to the bus. Generally, the following system can be connected to the I/O interface 1006: an input apparatus 1007 including, for example, a touch screen, a touch pad, a keyboard, a mouse, an image sensor camera, a microphone, an accelerometer, and a gyroscope, an output apparatus 1008 including, for example, a Liquid Crystal Display (LCD), a loudspeaker, and a vibrator, a storage apparatus 1003 including, for example, a magnetic tape, and a hard disk, and a communication apparatus 1009. The communication apparatus 1009 can allow the sight image processing system to perform wireless or wired communication with other electronic devices to exchange data. Although the sight image processing system with various systems is shown in figure, it is to be understood that it is not needed to implement or provided with all the shown systems. It can be alternatively implemented or provided with more or less systems.

Particularly, according to the embodiment of the present application, the process described with reference to the flowchart can be implemented as a computer software program. For example, an embodiment of the present application includes a computer program product which includes a computer program carried on a computer-readable medium, and the computer program contains program codes for executing the method in the flowchart. In such embodiment, the computer program can be downloaded and installed from a network through the communication apparatus, or installed from the storage apparatus 1003, or installed from the ROM 1002. When the computer program is executed by the processing apparatus 1001, functions defined in the method according to the embodiment of the present application can be realized.

The sight image processing system provided by the present application adopts the sight image processing method in the above embodiment, and can solve the technical problem that an existing bifocal digital sight needs to be switched between an infrared image picture and a visible light image picture back and forth, which is cumbersome in operation and inconvenient to use. Compared with the related technology, the sight image processing system provided by the present application has the same beneficial effects as the sight image processing method provided by the above embodiment, other technical features in the sight image processing system are the same as those disclosed by the sight image processing method provided by the above embodiment, which will not be listed here.

It is to be understood that all parts disclosed in the present application can be implemented by hardware, software, firmware, or a combination thereof. In the description of the above embodiments, specific features, structures, materials, or characteristics may be combined in an appropriate manner in any one or more embodiments or examples.

Correspondingly, an embodiment of the present application also provides a storage medium, with reference to FIG. 1, the storage medium is a computer-readable storage medium, a computer program is stored on the computer-readable storage medium, and the computer program is executed by a processor to implement the sight image processing method in any of the above embodiments.

The computer-readable storage medium provided by the present application may be, for example a U disk, but not limited to, an electrical, magnetic, optical, electromagnetic, infrared, or semiconductor system, apparatus or instrument, or any combination thereof. More specific examples of the computer-readable storage medium may be include, but not limited to, an electrical connector, a portable computer disk, a hard disk, a Random Access Memory (RAM), a Read Only Memory (ROM), an erasable programmable read only memory (EPROM or flash memory), an optical fiber, a portable compact disk read only memory (CD-ROM), an optical storage device, a magnetic storage device, or any suitable combination thereof having one or more wires. In this embodiment, the computer-readable storage medium may be any tangible medium containing or storing a program that may be used by or in combination with an instruction execution system, apparatus or instrument. The program code contained on the computer-readable medium may be transmitted with any suitable medium, including, but not limited to, an electrical wire, an optical cable, an RF (radio frequency), or any suitable combination thereof.

The above-mentioned computer-readable storage medium may be contained in the sight image processing system; and it can also exist on its own, without being assembled into the sight image processing system.

The computer-readable storage medium carries one or more programs, and when the one or more programs are executed by the sight image processing system, the sight image processing system can perform steps: acquiring the initial visible light image data and the initial infrared image data of the target region; performing image registration operation on the initial visible light image data and the initial infrared image data to obtain the registered visible light image and the registered infrared image; and performing image fusion operation on the registered visible light image and the registered infrared image to obtain the fused image.

The computer program code for executing the operations of the present application may be written in one or more programming languages or a combination thereof, including object-oriented programming languages, such as Java, Smalltalk, C++, and conventional procedural programming languages, such as “C” or similar programming languages. The program code can be executed entirely on a user computer, partially on the user computer, as a separate software package, partially on the user computer and partially on a remote computer, or entirely on the remote computer or server. In response to involve the remote computer, the remote computer may be connected with the user computer through any type of network, including the local area network (LAN) or the wide area network (WAN), or, may be connected to an external computer (e.g., via Internet service provider using Internet).

The flowchart and block diagram in the accompanying drawings illustrate the architecture, functions and operations that may be implemented by systems, methods and computer program products according to the various embodiments of the present application. In this regard, each block in the flowchart or block diagram may represent a module, program segment, or part of code, and the module, program segment, or part of code contains one or more executable instructions for implementing a prescribed logical function. It is also to be noted that in some alternative embodiments, the functions marked in the blocks may also occur in a different order than in the accompanying drawings. For example, two blocks represented in succession may actually be executed substantially in parallel, and sometimes in an opposite order, depending on the function involved. It is also to be noted that each block in the block diagram and/or flowchart, and the combination of blocks in the block diagram and/or flowchart, may be implemented in a dedicated hardware-based system that executes the prescribed function or operation, or may be implemented in a combination of dedicated hardware and computer instructions.

The modules involved in the embodiments of the present application can be implemented either in software, or in hardware. The names of the modules do not form a limitation to the unit itself in some cases.

The storage medium provided by the present application is the computer-readable storage medium, and the computer-readable storage medium stores a computer-readable program instruction (i.e., a computer program) that is used for executing the sight image processing method, and can solve the technical problem that the existing bifocal digital sight needs to be switched between an infrared image picture and a visible light image picture back and forth, which is cumbersome in operation and inconvenient to use. Compared with the related technology, the beneficial effect of the computer-readable storage medium provided by the present application is the same as that of the sight image processing method provided by the above embodiment, which will not be listed here.

It is to be noted that if there are directional indications (such as up, down, left, right, front, back . . . ) in the embodiment of the present application, the directional indications are only used for explaining the relative position relationship, movement conditions, and the like between the components in a specific posture. If the specific posture changes, the directional indications will also change accordingly.

In addition, if there are descriptions involving “first”, “second”, etc. in the embodiments of the present application, the descriptions of “first”, “second”, etc. are only for descriptive purposes and shall not be understood as indications or implications of its relative importance or implicit indication of the number of technical features indicated. Therefore, features defined as “first” and “second” may explicitly or implicitly include at least one of these features. In addition, if “and/or” or “as well as/or” appears throughout the text, its meaning includes three parallel solutions. Taking “A and/or B” as an example, it includes solution A, or solution B, or a solution that A and B are met at the same time. In addition, the technical solutions in various embodiments can be combined with each other, but it must be based on the realization by those of ordinary skill in the art. When the combination of technical solutions is contradictory or cannot be realized, it is to be considered that such a combination of technical solutions does not exist, nor within the protection scope required by the present application.

According to the disclosure and teaching of the above description, those skilled in the art of the present application may also make changes and modifications to the above embodiments. Therefore, the present application is not limited to the specific embodiments revealed and described above, and some modifications and changes to the present application should also fall within the protection scope of the claims of the present application. In addition, although some specific terms are used in this specification, they are for illustrative purposes only and do not constitute any limitation on the present application.

What is claimed is:

1. A sight image processing method, comprising the following steps:
acquiring initial visible light image data and initial infrared image data of a target region;
performing image registration operation on the initial visible light image data and the initial infrared image data to obtain a registered visible light image and a registered infrared image; and
performing image fusion operation on the registered visible light image and the registered infrared image to obtain a fused image.

2. The sight image processing method according to claim 1, wherein the step of performing image registration operation on the initial visible light image data and the initial infrared image data to obtain a registered visible light image and a registered infrared image comprises:
extracting a first feature point of the initial visible light image data;
extracting a second feature point of the initial infrared image data;
computing a registration matrix based on the first feature point and the second feature point; and
aligning the initial visible light image data and the initial infrared image data by the registration matrix.

3. The sight image processing method according to claim 2, wherein the first feature point comprises any one or more of corner points, edge points, texture regions and interest points.

4. The sight image processing method according to claim 2, wherein the second feature point comprises any one or more of corner points, edge points, texture regions and interest points.

5. The sight image processing method according to claim 2, wherein the step of computing a registration matrix based on the first feature point and the second feature point comprises:
performing feature point matching operation on the first feature point and the second feature point to obtain a feature point matching result; and
computing the registration matrix according to the feature point matching result.

6. The sight image processing method according to claim 5, wherein the step of performing feature point matching operation on the first feature point and the second feature point comprises:
performing the feature point matching operation on the first feature point and the second feature point by at least one of a Brute-Force algorithm, a FLANN algorithm and an RANSAC algorithm.

7. The sight image processing method according to claim 5, wherein the step of computing the registration matrix according to the feature point matching results comprises:
computing the registration matrix by at least one of rigid transformation, affine transformation, perspective transformation and thin plate spline interpolation.

8. The sight image processing method according to claim 1, wherein the step of performing image fusion operation on the registered visible light image and the registered infrared image comprises:
selecting a first image region and a second image region from the registered infrared image, wherein at least a part of the first image region is in the second image region, and color difference exists between the first image region and the second image region; and
overlaying the color of the first image region and the color of the second image region to a corresponding region of the registered visible light image.

9. The sight image processing method according to claim 8, wherein before the step of performing image fusion operation on the registered visible light image and the registered infrared image, the method comprises:
carrying out graying processing on the registered visible light image.

10. The sight image processing method according to claim 1, wherein the step of performing image fusion operation on the registered visible light image and the registered infrared image comprises:
selecting the first image region and the second image region from the registered infrared image, wherein at least a part of the first image region is in the second image region, and color difference exists between the first image region and the second image region;
performing edging processing on boundaries of the first image region and the second image region with a first target color to obtain a target contour line; and
overlaying the target contour line to the boundary of the corresponding region of the registered visible light image.

11. The sight image processing method according to claim 10, wherein before the step of performing image fusion operation on the registered visible light image and the registered infrared image, the method comprises:
carrying out graying processing on the registered visible light image.

12. The sight image processing method according to claim 1, wherein the step of performing image fusion operation on the registered visible light image and the registered infrared image comprises:
selecting the first image region and the second image region from the registered infrared image, wherein at least a part of the first image region is in the second image region, and color difference exists between the first image region and the second image region;
overlaying the color of the first image region and the color of the second image region to the corresponding region of the registered visible light image to obtain a pseudo-color fused image;
selecting the first image region and the second image region from the registered infrared image, wherein at least a part of the first image region is in the second image region, and color difference exists between the first image region and the second image region;
performing edging processing on the boundaries of the first image region and the second image region with the first target color to obtain the target contour line;
overlaying the target contour line to the boundary of the corresponding region of the registered visible light image to obtain the contour fused image;
acquiring external environment parameters; and
dynamically selecting the pseudo-color fused image or the contour fused image as a final display image according to the external environment parameters.

13. The sight image processing method according to claim 12, wherein the external environment parameters comprise environmental illumination intensity.

14. The sight image processing method according to claim 1, wherein after the step of performing image fusion operation on the registered visible light image and the registered infrared image, the method comprises:
acquiring the external environment parameters; and
according to the external environment parameters, dynamically adjusting a fusion weight between the registered visible light image and the registered infrared image.

15. The sight image processing method according to claim 14, wherein the external environment parameters comprise the environmental illumination intensity.

16. The sight image processing method according to claim 1, wherein before the step of performing image registration operation on the initial visible light image data and the initial infrared image data, the method comprises:
performing image preprocessing operation on the initial visible light image data and/or the initial infrared image data.

17. The sight image processing method according to claim 16, wherein the image preprocessing operation comprises any one or more of bad pixel correction, noise reduction, filtering, gamma correction, image enhancement and scaling.

18. A sight image processing apparatus, comprising:
an acquisition module, configured to acquire initial visible light image data and initial infrared image data of a target region;
a registration module, configured to perform image registration operation on the initial visible light image data and the initial infrared image data to obtain a registered visible light image and a registered infrared image; and
a fusion module, configured to perform image fusion operation on the registered visible light image and the registered infrared image to obtain a fused image.

19. A bifocal digital sight, comprising the sight image processing apparatus according to claim 18.

20. The bifocal digital sight according to claim 19, further comprising an objective lens optical module, a display apparatus and an eyepiece optical module, wherein the objective lens optical module is arranged at an input end of the acquisition module; the display apparatus is electrically connected to the fusion module and configured to present the fused image; and the eyepiece optical module is arranged at a display end of the display apparatus.
